(19) United States
(12) Patent Application Publication
(10) Pub. No.: US 2003/0216846 A1
(43) Pub. Date: Nov. 20, 2003

(54) Car computer operation apparatus

(76) Inventor: Ryan Chang, Tu Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/146,884

(22) Filed: May 17, 2002

(51) Int. Cl. G06F 17/00

(52) U.S. Cl. 701/36; 701/1

(57) ABSTRACT

A car computer operation module includes a first control panel, a screen with a second control panel, a media device including a load/eject control module and a player, a first control circuit electrically connected to the first control panel and media device, a global positioning system (GPS) for receiving radio signals from a GPS satellite and outputting position measurement data and a first driving device, and a second control circuit electrically connected to the screen and the first control circuit. The operating modes of this computer operation apparatus are switched by pressing a single button on the first control panel.

### BACKGROUND OF THE INVENTION

1. Field of the Invention

The present invention relates to a car computer operation module, and more particularly, to a car computer operation module integrating functions of car navigation and audio/video devices together therewithin.

2. Description of the Prior Art

As people spend more and more time in their cars, the car not only functions as a transportation means, but also is expected to play another role to meet the needs of people in work or life. The “e-trend” concept proposed by car manufacturers is to transform advanced information technologies into consumer-orientating devices as options that support various needs of the car users. For example, these consumer-orientating devices include liquid crystal displays, VCD, video game systems, advanced stereo systems, DVD, MP3, or car navigation systems, all of which are usually selected by car users for increasing the driving pleasure.

A conventional car navigation system is used to display an electronic road map so as to guide a driver to his destination. Typically, a car navigation system includes an information processing device, a display screen such as a liquid crystal display (LCD) screen, a global positioning system (GPS) data receiver, a media device such as a DVD/CD ROM or a small-size memory card reader. The media device is used to play electronic map software stored in a compact disk or the like. The information processing device is used to process received GPS data and is the heart of the conventional car navigation system.

However, the prior art car navigation system has a shortcoming that operation buttons for operating the GPS and DVD or CD ROM are installed on different control panels, leading to inconvenience. Further, the media device of the conventional car navigation system can only be used to execute the electronic map software. Namely, the media device of the conventional car navigation system cannot provide other entertainment-related functions.

### SUMMARY OF THE INVENTION

It is a primary objective of the present invention to provide a car computer operation apparatus occupying a smaller space and having a global positioning system integrated with a driving device of a media device through the same control circuit. Operation modes of this car computer operation module are switched from an audio/video playing mode and a GPS guiding mode.

Another objective of the present invention is to provide a car computer operation apparatus to avoid that a disk still rotates when a player of the media device ejects the disk out.

Still another objective of the present invention is to provide a car computer operation apparatus incorporating a reduced size of screen thereon.

According to the claimed invention, a car computer operation apparatus is provided. The car computer operation apparatus includes a first control panel, a screen with a second control panel, a media device having a load/eject control module and a player, a first control circuit electrically connected to the first control panel and media device having a processing unit, a global positioning system (GPS) for receiving radio signals from a GPS satellite and outputting position measurement data, and a first driving device, and a second control circuit electrically connected to the screen and the first control circuit having a panel controller and a second driving device. By this way, a single button is pressed to switch operating modes, and the processing unit selectively processes outputs of the player and GPS, thereafter, transmits corresponding video signals to the screen.

It is to be understood that both the forgoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

FIG. 1 is a schematic view of a present invention car computer operation module with an LCD monitor.

FIG. 2 is a schematic, plane view of this invention.

FIG. 3 is a block diagram illustrating the circuits of this invention.

FIG. 4A is a flow chart regarding disk ejection according to this invention.

FIG. 4B is a flow chart regarding disk loading and reading according to this invention.

FIG. 5A to FIG. 5C are schematic diagrams illustrating the present invention in use.

### DETAILED DESCRIPTION OF THE PREFERRED EMBODIMENT

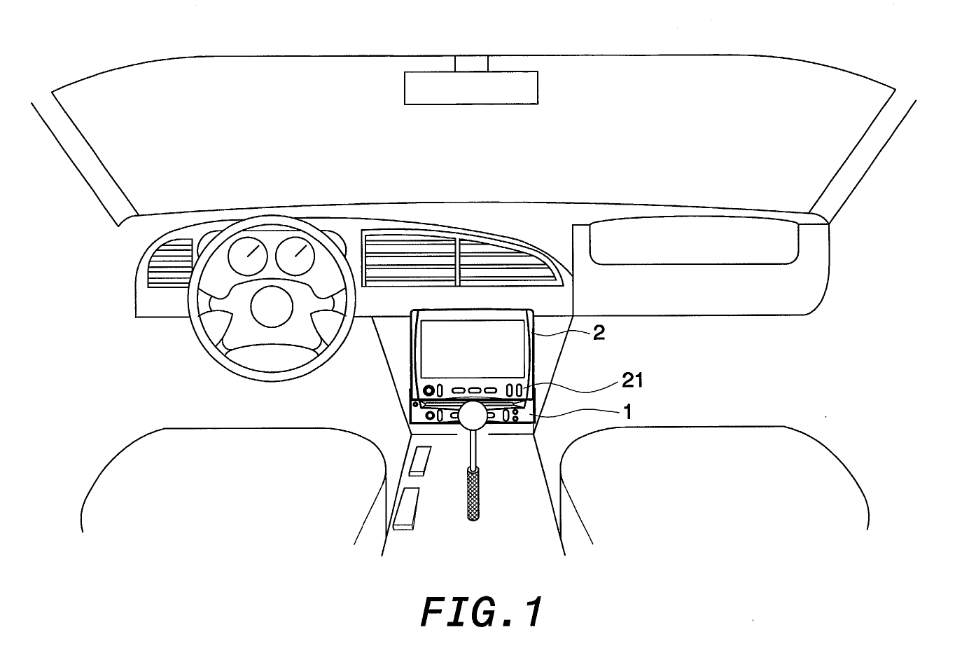

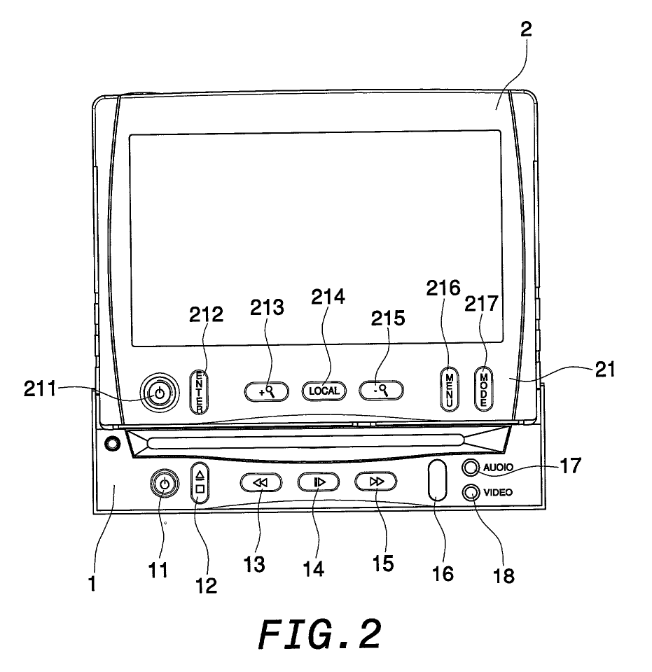

The present invention is directed to a car computer operation apparatus. Referring to FIG. 1 and FIG. 2, the car computer operation apparatus of one preferred embodiment of this invention includes a first control panel 1 that is associated with a media device. On the first control panel 1, there are some functional buttons such as an ON/OFF button 11, a stop/eject button 12, a “previous track” button 13, a play/pause control button 14, and a “next track” button 15. Normally, at the right side of these functional buttons, there are infrared transmission port 16, an audio interface 17, and a video interface 18. A screen 2 is installed over the first control panel 1. The screen 2 is preferably a 6.5-inch liquid crystal display (LCD) screen. In some cases, the screen 2 may be a cathode ray tube (CRT) screen. A second control panel 21 is mounted on the peripheral area of the screen 2. On the second control panel 21, there are a power button 211, an input button 212, an image-magnifying button 213, a localizing button 214, and an image-shrinking button 215. Further, there is a menu button 216 provided for a user to select options presented in a menu. Further, a mode-changing button 217 is provided for changing operating modes between an audio/video playing mode including VCD/MP3/DVD modes and a GPS guiding mode. The power button 211 is provided for switching the power of the screen 2.

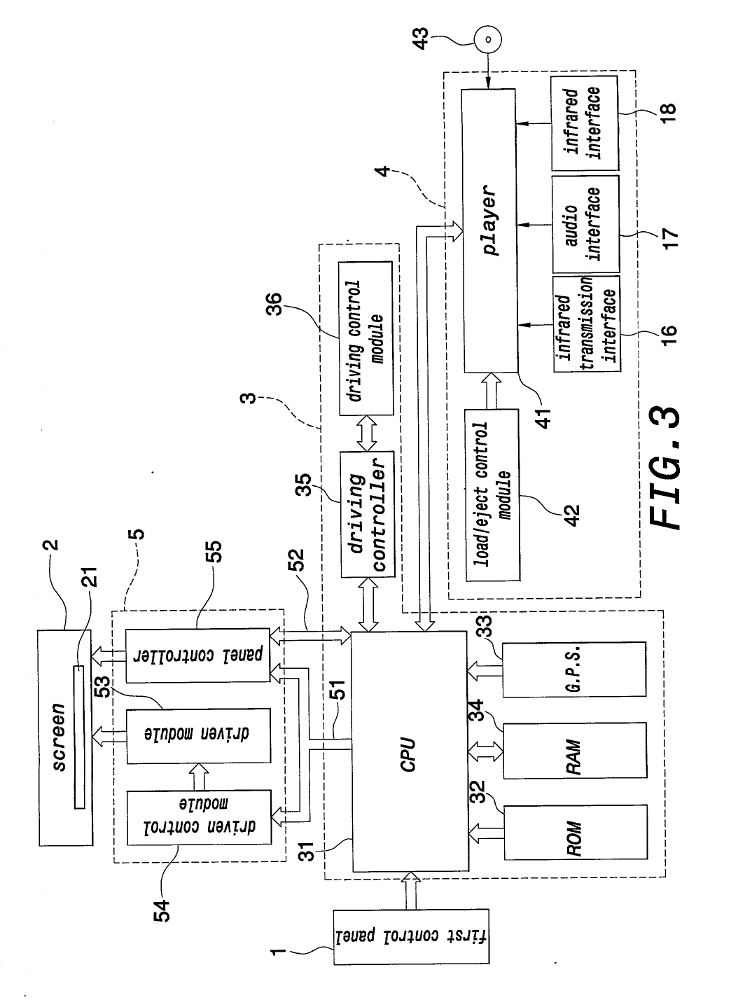

The preferred embodiment will be described in detail with reference to FIG. 3. As shown in FIG. 3, the first control panel 1 of FIG. 2 is electrically connected to a first control circuit 3, and, through the first control circuit 3, the first control panel 1 is connected to a media device 4 having a player 41 and a load/eject control module 42. The player 41 may be a CD-ROM drive, a DVD-ROM drive, or a memory card reader. The load/eject control module 42 is used to control the loading or ejection of a compact disk 43. The player 41 is electrically connected to the infrared transmission port 16, audio interface 17, and video interface 18. The infrared transmission port 16 provides a user with a remote control function by means of an infrared remote controller (not shown). Through the audio interface 17 and the video interface 18, a user is able to input audio/video signals stored in a portable electronic device into the computer of this invention via proper cables.

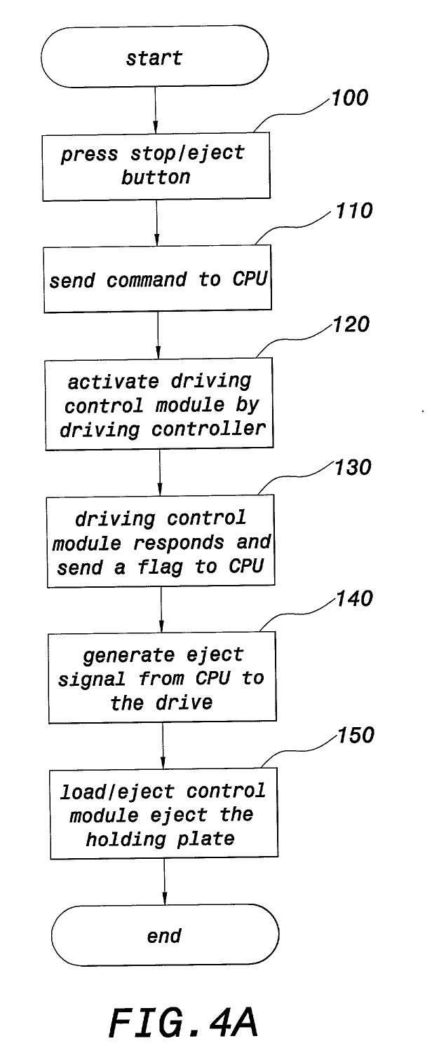

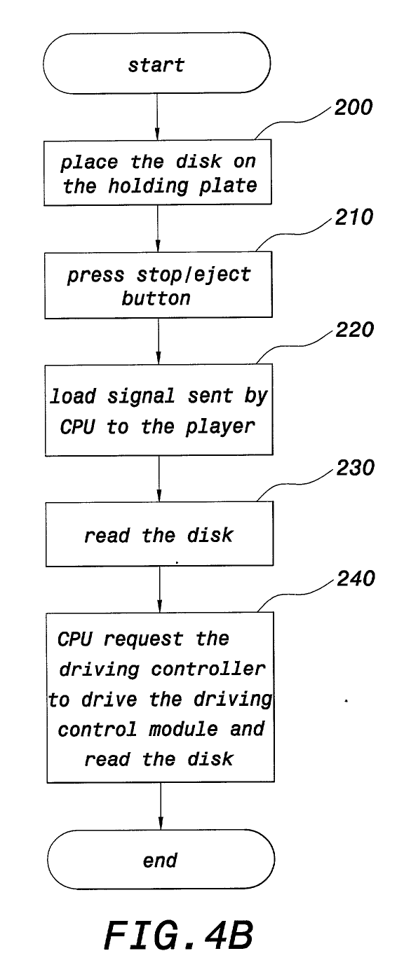

Still referring to FIG. 3, the first control circuit 3 further includes a central processing unit (CPU) 31 serving as the heart of the first control circuit 3, a read only memory (ROM) 32 for storing a control program for the first control circuit 3, and a global positioning system (GPS) 33 for receiving radio signals transmitted from a GPS satellite (not shown either). The corresponding position measurement data and relevant coordinates are stored in a random access memory (RAM) or a dynamic random access memory (DRAM) 34. A driving controller 35 is also provided in the first control circuit 3. The driving controller 35 is controlled by the CPU 31 to drive a driving control module 36 that is electrically connected to the driving controller 35, thus actuates the player 41 to load or eject compact disks, as best seen in FIG. 4A and FIG. 4B.

Assuming that the player 41 is reading the disk 43, in step 100, when a user presses the stop/eject button 12 of the first control panel 1, a command is sent to the CPU 31 (step 110), thereby controlling the driving controller 35 to drive the driving control module 36 (step 120) and then stopping the reading and responding to the request of disk eject command. After responding to the disk eject command by the driving control module 36, a flag is sent back to the CPU 31 (step 130). Next, an eject control signal generated by the CPU 31 is transmitted to the player 41 (step 140). Thereafter, the load/eject control module 42 will drive a holding plate (not shown) of the player 41 to move out from the player 41, thereby facilitating the disk change. Accordingly, an undesired situation that the disk still rotates when the player 41 starts to eject the holding plate may be avoided.

When one needs to reload a disk into the player 41, the disk 43 is placed on the holding plate (step 200). In step 210, the stop/eject button 12 is pressed. Instep 220, a loading control signal generated by the CPU 31 is transmitted to the player 41. By doing this, the holding plate will be absorbed back into the player 41. Of course, one may push the holding plate slightly to do the same. In step 230, the CPU 31 will request the driving controller 35 to drive the driving control module 36, thereby implementing the reading of the information on the disk 43 (step 240). As compared with the prior art, the driving circuit of this invention is separated from the media device 4 and is installed in the first control circuit 3.

Referring to FIG. 3, the second control circuit 5 is connected to the first control circuit 3 through the control signal interface 51 and a display signal interface 52. The second control circuit 5 comprises a driven module 53, a driven control module 54, and a panel controller 55. The driven module 53 further includes a plurality of motor gears. The driven control module 54 is connected to the CPU 31 through the control signal interface 51, and further connected to the driven module 53. When a user presses the power button 11 on the first control panel 1, another command is sent to the CPU 31. After the command being processed, a corresponding control signal is sent through the control signal interface 51 to the driven control module 54 to drive the driven module 53 for the sake of moving the first control panel 1 forwards or backwards.

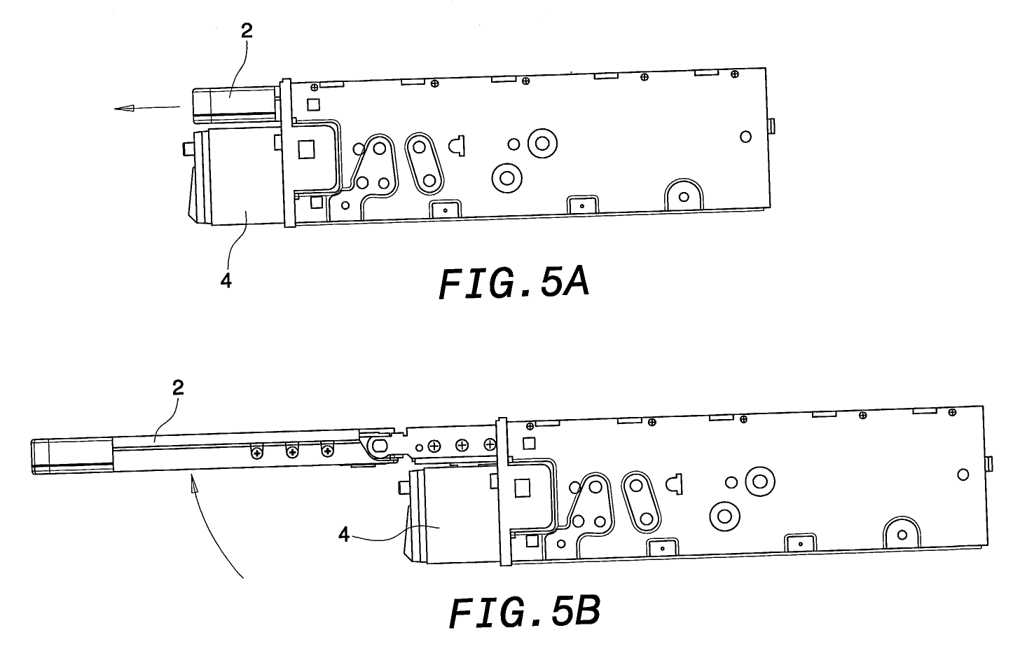

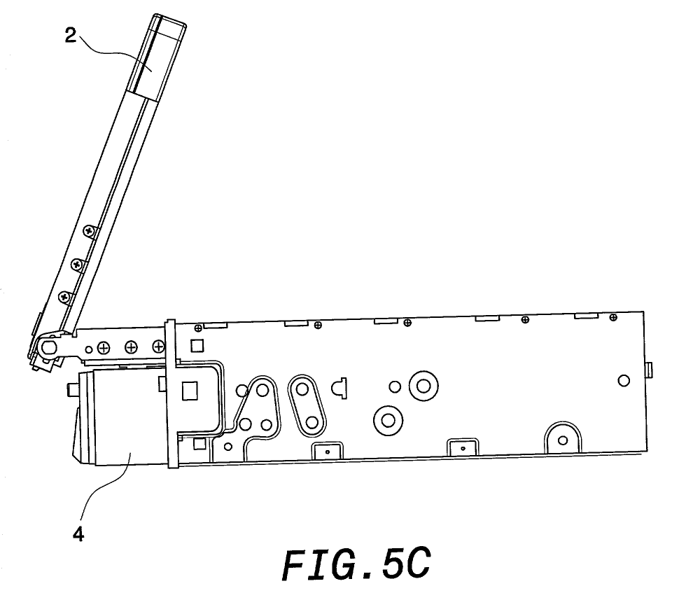

Referring to FIG. 5A through FIG. 5C, when the first control panel 1 is moved backwards, it may be stored in a recess (not shown) located at the upper portion of the player 41. As best seen in FIG. 5C, the screen 2 may be pivotally and manually rotated to the extent that the screen 12 is not against other components of this computer operation module.

The second control panel 21 on the periphery of the screen 2 is electrically connected to the CPU 31. When a user presses the mode-changing button 217 on the second control panel 21, the operating modes of the screen 2 is switched between the, audio/video playing mode including VCD/MP3/DVD modes and the GPS guiding mode. Namely, the CPU 31 will selectively process outputs of the player 41 and GPS 33, and then transmit corresponding video signals of these outputs to the panel controller 55 through the video signal interface. After implementing an analogy/digital conversion process, the video signals will be sent to the screen 2 and play. It is advantageous that the present invention provides the mode-changing button 217 so that one can change the operating modes of the screen 2 between the audio/video playing mode including VCD/MP3/DVD modes and the GPS guiding mode by simply pressing one button. Further, this invention occupies a smaller space since the panel controller 55 is separated from the screen 2. Moreover, it just consumes less power for the driven control module 54 to drive the screen 2.

Those skilled in the art will readily observe that numerous modification and alterations of the device may be made while retaining the teachings of the invention. Accordingly, the above disclosure should be construed as limited only by the metes and bounds of the appended claims.

What is claimed is:

1. A car computer operation apparatus, comprising:
a first control panel;
a screen with a second control panel;
a media device having a load/eject control module and a player;
a first control circuit electrically connected to the first control panel and the media device, the first control circuit having a processing unit serving as the heart of the first control circuit, a global positioning system (GPS) for receiving radio signals transmitted from a GPS satellite and outputting position measurement data, and a first driving device; and
a second control circuit electrically connected to the screen and the first control circuit, the second control circuit having a panel controller and a second driving device, the second driving device being controlled by the processing unit for moving the screen;
wherein a single button on the second control panel is pressed to switch an operating mode of the screen from an audio/video playing mode and a GPS guiding mode, the processing unit selectively processes outputs of the player and the GPS and transmits corresponding video signals of the outputs to the screen.

2. The car computer operation apparatus of claim 1 wherein the first control panel and the second control panel comprise at least one function button thereon, respectively.

3. The car computer operation apparatus of claim 1 wherein the media device comprises an infrared transmission port, an audio interface, and a video interface.

4. The car computer operation apparatus of claim 1 wherein the processing unit comprises a CPU, a read only memory (ROM), and a random access memory (RAM).

5. The car computer operation apparatus of claim 1 wherein the first driving device comprises a driving controller and a driving control module.

6. The car computer operation apparatus of claim 1 wherein the second driving device comprises a driven control module and a driven module.

7. The car computer operation apparatus of claim 6 wherein the driven module comprises a plurality of motor gears.
